(19) United States
(12) Patent Application Publication
(10) Pub. No.: US 2020/0403267 A1
(43) Pub. Date: Dec. 24, 2020

(54) HIGH-VOLTAGE SOLID-STATE LITHIUM-ION BATTERY WITH RATIONAL ELECTRODE-ELECTROLYTE COMBINATIONS

(71) Applicant: GM GLOBAL TECHNOLOGY OPERATIONS LLC, Detroit, MI (US)

(72) Inventors: Zhe Li, Shanghai (CN); Mengyan Hou, Shanghai (CN); Haijing Liu, Shanghai (CN); Dewen Kong, Minhang (CN); Yong Lu, Shanghai (CN)

(21) Appl. No.: 16/446,702

(22) Filed: Jun. 20, 2019

(51) Int. Cl. H01M 10/0525; H01M 10/04; H01M 4/38; H01M 4/525

(52) U.S. Cl. CPC H01M 10/0525; H01M 4/525; H01M 4/382; H01M 10/044

(57) ABSTRACT

A lithium-ion battery cell is formed of a layer of anode material comprising a mixture of anode active material particles and particles of a first solid electrolyte composition, an electrolyte layer of solid electrolyte particles of a second solid electrolyte composition, and a layer of cathode material comprising a mixture of cathode active material particles and particles of a third solid electrolyte compositions. In the cell, the three solid electrolyte compositions are varied to enhance the performance of the cell. Layers of interlayer material are placed between one or both of the layers of electrode material and the solid electrolyte material and/or between electrolyte layers. And, optionally, the otherwise solid-state cell is infiltrated with a suitable liquid electrolyte. These variables are managed to enhance macro/micro interfaces between the solid materials and layers and to improve the electrochemical performance of the cell, especially for high-voltage cathode material.

### INTRODUCTION

Lithium-ion batteries can be composed and formed to provide effective energy for powering electric motor driven vehicles and for powering many other consumer products. Some lithium-ion batteries use a liquid electrolyte and others use a solid electrolyte. For commercial applications, it is desirable to enhance safety and increase power/energy densities of such lithium-ion battery cells by using solid electrolytes. In existing solid-state lithium-ion electrochemical battery cells, particles of a common solid electrolyte composition are used as the solid electrolyte layer (also known as separator layer) and in mixtures with electrode active particles in both the anode and cathode layers of the cell. However, it has been found that such a practice can present serious performance issues in the lithium-ion cell. A macro-interface in a cell, between an electrolyte layer of solid electrolyte particles and an adjoining coextensive electrode layer of mixed electrode material particles and solid electrolyte particles, is usually poor and can result in a large interfacial resistance. Also, lithium dendrite growth can occur when graphite or lithium metal is used as the anode material. In addition, the commonly-used solid electrolyte composition has a limited electrochemical window, and cannot enable a good electrochemical compatibility with both anode and cathode active material simultaneously. For example, sulfide-based solid electrolyte could have a good electrochemical compatibility with anode active material such as graphite, however, it cannot match well with the high-voltage cathode active material such as 5V LiNi0.5Mn1.5O₄. This practice can also cause micro-interface issues between mixed nanometer/micrometer-size particles of electrode (anode or cathode) active material particles and particles of solid electrolyte, and adversely affect the cell performance of the lithium-ion cell.

In this disclosure, the performance of lithium-ion battery cells, especially using relatively high-voltage cathode active material, is increased by building up stabilized and favorable micro-interfaces between the particles of anode active material and particles of a selected solid electrolyte in an anode layer of the battery cell, where the anode active material has a good chemical/electrochemical compatibility with this selected solid electrolyte. Likewise, stabilized and favorable micro-interfaces are obtained between the cathode active particles and suitably selected solid electrolyte particles in the cell's cathode layer. Further, it is found that the macro-interface between the anode layer, and/or the cathode layer, and the coextensive, interposed, solid electrolyte layer is improved by introducing a suitable thin interlayer film between the electrode layer and the selected solid electrolyte layer. The function of the interlayer film material is to enable an intimate interfacial connection and minimize the interfacial resistance at the macro-interface between the anode layer and/or the cathode layer and the coextensive solid electrolyte layer of the cell.

### SUMMARY OF THE DISCLOSURE

In an illustrative initial example, a solid-state lithium-ion battery cell is formed using a selectively shaped (e.g., rectangular) and uniformly thick anode layer that includes particles of anode active material (e.g., such as graphite particles), a like-shaped and uniformly thick cathode layer that includes cathode active material particles (such as high-voltage, 5V, LiNi_{0.5}Mn_{1.5}O₄ particles, sometimes LMNO in this specification). The anode layer and cathode layer are placed against opposite coextensive faces of a compatibly-shaped, uniformly thick layer of solid-electrolyte particles (such as Li₁₀GeP₂Si₂). The electrode and electrolyte particles are sometimes of a roughly spherical shape with largest dimensions in the range of about 2 nanometers to about 1000 micrometers. The thicknesses of the respective cell member layers (typically in the range of about 5-1000 micrometers for one layer) are based on their composition and their required electrochemical capacity in the cell unit. Such a basic cell unit may be electrically interconnected with like cell units to achieve a desired multi-cell battery voltage, power and energy. The performance of the electrochemical cell requires good conduction of lithium cations.

In prior practices, particles of the same single solid electrolyte material, e.g., Li₁₀GeP₂Si₂, are mixed with the anode active material particles and the cathode active material particles, and are also used as the solid electrolyte layer material for the solid-state battery. But it has proven to be difficult to find an appropriate single solid electrolyte composition that serves well, providing stable particle-to-particle micro-interfaces when mixed with both particles of a selected anode active material and also with particles of a selected cathode active material composition, due to the limited electrochemical window of the solid electrolyte. Moreover, when the same solid electrolyte is placed, as a coextensive layer of solid electrolyte material, between the layers of anode material and cathode material, the formed layer-to-layer macro interfaces are often poor. In accordance with this disclosure, that practice is not followed.

In accordance with practices of embodiments of this disclosure, specific, often different, solid electrolyte compositions are selected for mixture with each of the anode active material and the cathode active material. In the case of selections of a solid electrolyte for the anode layer mixture, these choices are made, for example, to enhance particle-to-particle micro-interfaces stability within the mixed electrode layers, to improve chemical compatibility within the anode active material, to reduce small grain boundary resistance, and to inhibit lithium dendrite formation (e.g., in a graphite or lithium anode). The solid electrolyte particle composition selected for the cathode mixture is chosen to enhance thermodynamic stability in high cell potential ranges (e.g., close to 5V), and/or to minimize elemental diffusion and space-charge layer effect. A further different solid electrolyte particle composition, with high lithium ionic conductivity and low electronic conductivity, may be used for the solid electrolyte layer composition.

In accordance with a further embodiment of this disclosure a relatively thin interface film layer composition(s) is preferably often selected for placement between the anode layer, and/or the cathode layer, and the interposed solid electrolyte layer. For example, the purpose of the interlayer material film is to improve the interface connection and to minimize interfacial resistance between the anode or cathode material layer and the adjoining solid electrolyte layer, to form a gradient change of lithium ions, to avoid side-reactions between the respective layers, and to suppress lithium dendrite nucleation (e.g., when using graphite or lithium anode active material).

In the development of a specific lithium-ion battery cell combination for a specific application of the cell, or group of cells, a specific electrode active material composition is chosen for each of the anode active material (particles) and the cathode active material (particles). In accordance with some practices of this disclosure, a first specific composition is chosen for the particles of the solid electrolyte to be mixed with the anode active material particles (SE1 composition in this specification), a different specific composition is chosen for the particles of the solid electrolyte to be mixed with the cathode active material particles (SE3), and a third specific composition is chosen for the particles of solid electrolyte material (SE2) to be used in the electrolyte layer placed between the particulate anode material layer and the particulate cathode material layer of each electrochemical cell of the lithium-ion battery. In one embodiment of this disclosure, each of the three specific electrolyte compositions is different from the other two electrolyte compositions. That is, SE1≠SE2≠SE3. Each of the three particulate solid electrolyte compositions is specifically selected for its location and function in the cell.

In another embodiment of this disclosure, a common electrolyte composition may be used only in two members of the anode layer, the cathode layer, and solid electrolyte layer.

Furthermore, in lithium-ion battery cells it is preferred to place a thin interlayer film of particles between the anode layer of mixed particles and the solid electrolyte layer and/or between the solid electrolyte layer and the cathode layer of mixed particles.

As a general, illustrative example, the weight proportions of the constituents in an individual electrode mixture will comprise about forty percent by weight or more of the anode or cathode active material particles, up to about sixty percent by weight of the particles of the selected solid electrolyte composition, and, optionally, a minor portion of conductive particles (such as conductive carbon particles) and/or a minor portion of a compatible binder material (often a polymeric binder material). The maximum major dimension of the generally spherical or irregularly shaped particles will typically be in the nanometer-size range (2 nm or larger) or the micrometer-size range, less than 1000 micrometers.

Preferably, solid electrolyte particles selected for mixing with anode active material particles are chemically compatible with the anode material, present low grain boundary resistance, mix in intimate contact with the anode particles, and inhibit lithium dendrite formation (e.g., when used in a graphite or lithium metal anode). Solid electrolyte particles for the solid electrolyte layer must provide high lithium ion conductivity and low electronic conductivity. Solid electrode particles selected for mixing with cathode active material particles must be thermodynamically stable in high voltage potential ranges (e.g., about 5V), and present minimal space-charge layer effect and diffusion of elements with the cathode particles.

As stated above, in one embodiment, a cell may be formed using a different solid electrolyte material composition for each layer member of the cell, and a thin interlayer is placed between the anode layer (and/or the cathode layer) and the solid electrolyte layer. In an illustrative example, lithium-ion battery anode material is formed of a mixture containing of graphite particles, Li_{9.6}P₃S₁₂ solid electrolyte particles and other components such as polymer binder and conductive particles. A thin interlayer film (e.g., a few micrometers in thickness) of polyethylene oxide-bonded (PEO), lithium bis(trifluoromethanesulfonyl) imide (LiTFSI) is placed co-extensively against the anode layer. In the cell, the solid electrolyte layer (co-extensively lying against the interlayer) is formed of particles of Li₁₀GeP₂S₁₂ (LGPS). And the cathode layer, lying co-extensively against the other side of the solid electrolyte layer, is formed of a particulate mixture of Li₇La₃Zr₂O₁₂/polyvinylidene fluoride (PVDF)/LiTFSI hybrid solid electrolyte, LiNbO₃-coated LNi_{0.5}Mn_{1.5}O₄ cathode active material, and other components such as polymer binder and conductive particles. This LIB cell is capable of producing four volts over repeated discharge and recharge cycles.

Obviously, groups of such cells may be electrically connected in series (such as bipolar stacking) or parallel arrangement to produce a required voltage and capacity/energy in a battery of such cells.

In other embodiments of the disclosure, depending on specific electrode material/solid electrolyte particle compatibilities at the micro-interface level, two of the electrode members and the solid electrolyte layer of the cell may be formed with particles of the same solid electrolyte composition. Sometimes, a selected common electrolyte composition works satisfactorily in two locations within the three cell members.

In another embodiment of the disclosure, a film-like interlayer of particles is placed between both electrode layers and the interposed solid electrolyte layer. The purpose of the interlayer(s) is to serve to facilitate ion flow between an electrolyte layer and a facing electrode material layer. And an interlayer may resist lithium dendrite growth from the anode material layer. As illustrated above, each such interlayer may comprise mixtures of a polymer-based composition and a lithium-containing composition.

In another embodiment, the solid electrolyte layer may be formed of two overlying, co-extensive layers in which one solid electrolyte layer uses particles of the same solid electrolyte composition as is used in the anode and the other solid electrolyte layer uses particles of the same composition as the facing cathode layer. Optionally, a resin-bonded, particulate interlayer film may be placed between the two different solid electrolyte layers. And interlayers may be placed between the electrode layers and the bilayer solid electrolyte and its interlayer.

In still another embodiment, the solid-state cell may be infiltrated with a suitable amount of a suitable non-aqueous liquid electrolyte to supplement (but not replace) the function of the solid electrolyte particles used in the electrode layers and the solid electrolyte layer(s).

Further detailed disclosures of anode active material-solid electrolyte combinations, solid electrolyte layer combinations, cathode layer combinations, and interlayer materials are presented in following paragraphs of this specification.

### BRIEF DESCRIPTION OF THE DRAWINGS

FIG. 1 is a schematic, cross-sectional view of a cell of a solid-state lithium-ion battery. This illustrated battery cell is a six-layer structure of substantially like-shaped, overlying layers of different (but uniform) thicknesses and different material compositions. Starting from the top layer and proceeding downwardly—the top member is a non-porous nickel or copper current collector foil with its lower side in coextensive contact with a surface of a particulate anode material layer. The anode material layer contains particles of anode active material and a first solid electrolyte material (SE1). In this embodiment, the opposite side of the anode layer lies in coextensive contact against one side of an interposed interlayer material film. The opposite side of the interlayer is in co-extensive face-to face contact with a layer of particles of solid electrolyte material of a second electrolyte composition (SE2). The fifth layer is a cathode layer which contains particles of cathode active material uniformly mixed with particles of a third solid electrolyte material (SE3). The bottom layer of the battery cell is a non-porous aluminum current collector foil with one side in substantially coextensive contact with one side of the cathode layer. Each thin current collector foil may (optionally) have an un-coated tab on one edge for an electric contact with another interconnected cell unit and/or with a device requiring the electrical current produced by the cell. Obviously, groups of such cells may be electrically connected in series (such as bipolar stacking) or parallel arrangement to produce a required voltage and capacity/energy in a battery of such cells.

In FIG. 1, each member of the cell is identified with a numeral 1xx which is identified and described in the following specification. In many of the following figures, the battery cell contains some identical or closely-identical members. In these figures, each member is identified with a numeral Xxx in which X is the number of the figure, and the numerals xx correspond to the numeral used in FIG. 1 to identify the described cell member.

FIG. 2A is a schematic cross-sectional view of a cell of a solid-state battery. The six-layer structure is a schematic, cross-sectional view, quite similar to that of FIG. 1. The six-layer structure of FIG. 2A is like that of FIG. 1, except that the composition of the particles of solid electrolyte material (SE1) in the anode layer and the composition of the solid electrolyte particles (SE2) of the solid electrolyte layer are the same solid electrolyte composition. In the embodiment illustrated in FIG. 2A, SE1=SE2. In the embodiment of solid electrolyte compositions in FIG. 2A, the compositions of SE1 and SE2 are not the same as the SE3 composition.

FIG. 2B is a schematic cross-sectional view of a cell of a solid-state battery like that of FIG. 2A, except that the composition of the particles of solid electrolyte material (SE2) of the solid electrolyte layer and the composition of the solid electrolyte particles (SE3) mixed with the particles of cathode active material are the same. In the embodiment illustrated in FIG. 2B, SE2=SE3. In the embodiment of solid electrolyte compositions in FIG. 2B, the compositions of SE1 and SE2 are not the same.

FIG. 2C is a schematic cross-sectional view of a cell of a solid-state battery like that of FIGS. 2A and 2B, except that the composition of the particles of the solid electrolyte (SE1) mixed with the anode active material particles and the particles of the solid electrolyte (SE3) mixed with the particles of cathode active material particles are the same. The anode material layer and the cathode material layer use the same composition of solid electrolyte particles, SE1=SE3, which is different from the composition of the solid electrolyte layer (SE2).

FIG. 3 is a three-part, fragmented, schematic, cross-sectional view of a cell of a solid-state lithium-ion battery illustrating different embodiments of the placement of an interlayer between the anode material layer and the solid electrolyte layer and/or between the cathode material layer and the solid electrolyte layer. In the left fragmental view of FIG. 3, the interlayer is placed between upper layer of mixed anode material particles and solid electrolyte particles (SE1) and the layer of solid electrolyte particles. In the center fragmental view of FIG. 3, the interlayer is placed between the layer of solid electrolyte particles (SE2) and the lower layer of mixed cathode material particles and solid electrolyte particles (SE3). In the right-side fragmental view of FIG. 3, a particulate interlayer is placed between both the anode material layer and the solid electrolyte layer and the cathode material layer. In FIG. 3 SE1≠SE2≠SE3.

FIG. 4A is a schematic cross-sectional view of a solid-state lithium-ion battery illustrating two co-extensive layers of solid electrolyte material placed between the layer of anode material and the layer of cathode material. In FIG. 4A the upper particulate layer of solid electrolyte material is of the same composition as the particles of solid electrolyte material (SE1) mixed with the particles of anode active material, and the lower particulate layer of solid electrolyte material is of the same composition as the particles of solid electrolyte material (SE3) mixed with the particles of cathode active material particles. SE1≠SE3.

FIG. 4B is a schematic cross-sectional view (similar to FIG. 4A) of a cell of a solid-state lithium-ion battery illustrating two co-extensive layers of solid electrolyte material placed between the layer of anode material and the layer of cathode material. In FIG. 4B, an interlayer is placed between the two layers of solid electrolyte materials.

FIG. 5 is a schematic cross-sectional view of a cell of a solid-state lithium-ion battery similar to FIG. 1. In FIG. 5, the solid-state cell of FIG. 1 has been infiltrated with a liquid electrolyte of a composition compatible with the solid battery electrode and solid electrolyte members of FIG. 1.

### DETAILED DESCRIPTION

As stated, it is desired to form lithium battery cells in which cathode active material compositions and anode active electrode material compositions are paired with compatible and supportive particulate solid electrolyte material compositions in the respective electrode layers. Further, it is intended to utilize compatible solid electrolyte compositions, and, when necessary, suitable interlayer film compositions between layers of electrode materials and a solid electrolyte layer. Following are lists of exemplary, but non-limiting, compositions of such cathode, anode, electrolyte and interlayer materials:

Examples of suitable cathode active materials include high-voltage oxides. e.g., LiNi_{0.5}Mn_{1.5}O₄, rock salt layered oxides (LiCoO₂, LiNiₓMn_{y}Co_{1-x-y}O₂, LiNiₓMn₁₋ₓO₂, Li₁₊ₓMO₂), spinel (LiMn₂O₄), polyanion cathode (LiV₂(PO₄)₃), and other lithium transition-metal oxides and coated and/or doped cathode materials mentioned above. e.g., LiNbO₃-coated LiNi_{0.5}Mn_{1.5}O₄,

Examples of suitable solid electrolyte materials for use with particles of cathode active materials include:

Oxide solid electrolyte (SE) such as Perovskite type (Li₃ₓLa_{2/3-x}TiO₃), NASICON type (Li_{1.4}Al_{0.4}Ti_{1.6}(PO₄)₃ and Li₁₊ₓAlₓGe₂₋ₓ(PO₄)₃, LISICON type (Li₂₊₂ₓZn₁₋ₓGeO₄), garnet type (Li₇La₃Zr₂O₁₂).

Inorganic oxide SE/polymer hybrid electrolytes, e.g., Li_{6.4}La₃Zr_{1.4}Ta_{0.6}O₁₂/Li-salt-free polyethylene oxides (PEOs), Li_{6.75}La₃Zr_{1.75}Ta_{0.25}O₁₂/poly (propylene carbonate), Li₇La₃Zr₂O₁₂/polyethylene oxide, Li₇La₃Zr₂O₁₂/poly (vinylidene fluoride-hexafluoropropylene) (PVDF-HFP).

Inorganic oxide SE/polymer/lithium salt hybrid electrolyte. e.g., garnet/polyethylene-oxide/lithium salt (Li₇La₃Zr₂O₁₂/polyvinylidene fluoride (PVDF)/LiTFSI hybrid electrolyte)

Metal-doped or aliovalent-substituted oxide SE. e.g., Al (or Nb)-doped Li₇La₃Zr₂O₁₂, Sb-doped Li₇La₃Zr₂O₁₂ Ga-substituted Li₇La₃Zr₂O₁₂, Cr and V-substituted LiSn₂P₃O₁₂, Al-substituted perovskite.

high-voltage-stable sulfide solid electrolyte, such as core-shell Li_{9.54}Si_{1.74}P_{1.44}S_{11.7}Cl_{0.3}.

Lithium Phosphorus Oxynitride

Examples of suitable anode active material particles include:

Carbonaceous material (e.g. graphite, hard carbon, soft carbon etc.), silicon, silicon mixed with graphite, Li₄Ti₅O₁₂, transition-metal (e.g., Sn), metal oxide/sulfide (e.g., SnO₂, FeS and the likes), and other lithium-accepting anode materials.

Li Metal Foil and Li-Metal Alloy (Li—In).

Examples of solid electrolyte particles for use with particles of anode active electrolyte particles include:

Sulfide-based SE. e.g., Li₂S—P₂S₅, Li₂S-P₂S₅-MSₓ, Li₂S—P₂S₅ with LiI, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, and Li₁₀(Si_{0.5}Sn_{0.5})P₂S₁₂.

Surface-modified sulfide SEs. e.g., ZnO-deposited Li₂S—P₂S₅.

Lithium argyrodite-type SE. e.g., Li₆PS₅X (X═Cl, Br, or I).

Inorganic sulfide SE/polymer hybrid electrolyte. e.g., 77.5 Li₂S-22.5 P₂S₅/polyimine, LGPS/polyethylene oxide.

Inorganic sulfide SE/polymer/lithium salt hybrid electrolyte. e.g., LGPS/polyethylene oxide/LiTFSI.

Other SEs. e.g., LiPON.

Examples of suitable solid electrolyte compositions for the layer of solid electrolyte particles include: Sulfide-based SE. e.g., Li₂S—P₂S₅, Li₂S-P₂S₅-MSₓ, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS_{5X} (X═Cl, Br, or I), Li_{9.54}Si_{1.74}P_{1.44}S_{11.7}Cl_{0.3} (25 mS/cm), Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, and Li₁₀(Si_{0.5}Sn_{0.5})P₂S₁₂.

Oxide-based SE. e.g., perovskite type (Li₃ₓLa_{2/3}—ₓTiO₃), NASICON type (LiTi₂(PO₄)₃), Li₁₊ₓAlₓTi₂₋ₓ(PO₄)₃ (LATP), Li₁₊ₓAlₓGe₂₋ₓ(PO₄)₃ (LAGP), Li₁₊ₓYₓZr₂₋ₓ(PO₄)₃ (LYZP), LISICON type (Li₁₄Zn(GeO₄)₄), Garnet type (Li_{6.5}La₃Zr_{1.75}Te_{0.25}O₁₂).

Polymer-based SE: a polymer host is combined with a lithium salt solid electrolyte to act as a solid solvent. Polymer host: PEO, PPO, PEG, PMMA, PAN, PVDF, PVDF-HFP, PVC. Salts: lithium bis(trifluoromethanesulfonyl) imide (LiTFSI).

Nitride-based SE. e.g. Li₃N, Li₇PN₄, LiSi₂N₃.

Hydride-based SE. e.g. LiBH₄, LiBH₄—Li_{X} (X═Cl, Br or I), LiNH₂, Li₂NH, LiBH₄—LiNH₂, Li₃AlH₆

Halide-based SE. e.g. LiI, Li₂CdCl₄, Li₂MgCl₄, Li₂CdI₄, Li₂ZnI₄, Li₃OCl

Borate-based SE. e.g. Li₂B₄O₇, Li₂O—B₂O₃—P₂O₅

Inorganic SE/polymer-based hybrid electrolyte.

Surface-modified solid electrolyte materials. In-deposited Li₇La₃Zr₂O₁₂

Examples of suitable compositions for interlayer particle compositions include:

Inorganic interlayer (e.g., 70% Li₂S-29% P₂S₅-1% P₂O₅).

Polymer-based interlayer (e.g., poly (ethylene glycol) methyl ether acrylate with Al₂O₃ and LiTFSI; polyethylene oxide with LiTFSI; poly (vinylidene fluoride) copolymer with hexafluoropropylene (PVDF-HFP)-based gel electrolyte.).

Metal/metal oxide (e.g., Nb, Al, Si or Al₂O₃).

In the following illustrative figures, various embodiments of this disclosure are illustrated, particularly concerning the combinations of particulate electrode active materials and particulate solid electrolyte materials, adjoining solid electrolyte layers and interlayers used with solid electrolyte layers. In the respective illustrative figures, the thicknesses of the respective layers and the sizes of the particles of electrode materials are enlarged for purposes of the illustration. Illustrative, representative sizes of the electrode materials and the electrode elements themselves are presented above in this text and in following portions of this text. Further, only single battery unit cells are drawn and with the cell member layers presented in a horizontal posture to better fit the illustrations on a drawing sheet. In use, many battery cells may be assembled in upstanding stacks or rolls and many cells may be combined in an assembly in which they are connected in electrical series combination, electrical parallel combination, or in both electrical series and parallel combinations.

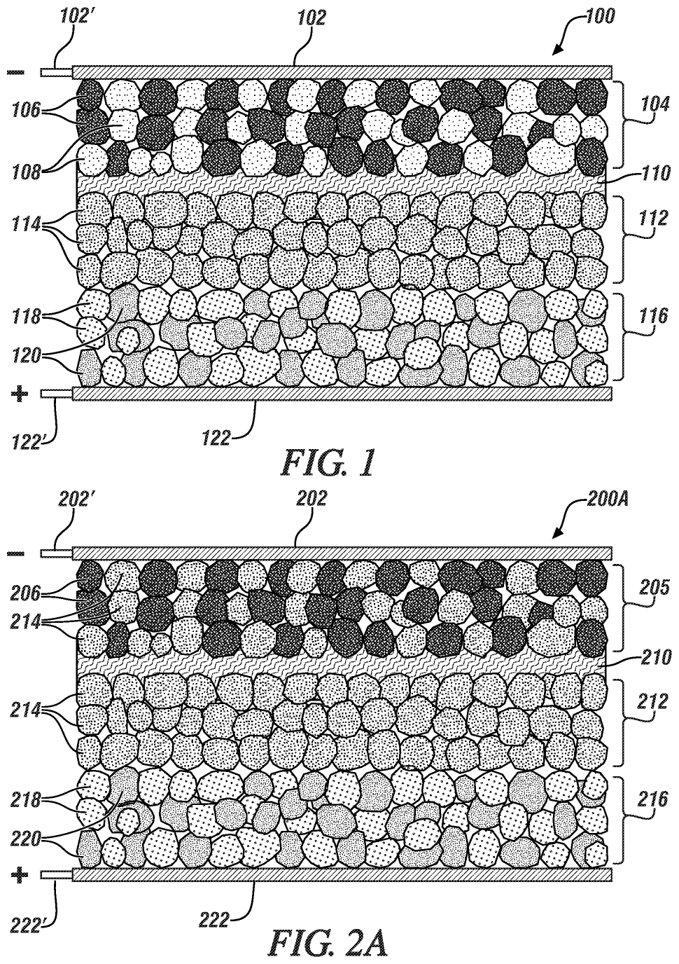

In FIG. 1, a lithium-ion battery cell 100 is illustrated in which three different solid electrolyte compositions are employed. Starting at the top of the figure, a thin, solid (non-perforated) current collector foil 102 has a uniformly thick, layer of anode material 104 co-extensively bonded to its lower side. In an assembled battery, comprising more than one cell, a like layer of anode material would likely be placed, coextensively, against its opposite side, its top side as illustrated in FIG. 1. The contact, which may be a resin-bonded contact (not illustrated), is such that, during cell operation, electrons enter the current collector 102, from the anode material layer 104 during cell discharge, flowing from an optional smaller tab 102′ at one side or edge of the current collector foil to an electrical energy consuming device. Thus, during cell discharge, anode current collector 102 is negatively charged. Anode current collector 102 is often a nickel or copper foil having a thickness of about five to fifty micrometers and a two-dimensional shape corresponding to the required shape and area of the attached anode material.

Anode material layer 104 is an intimate mixture of nanometer-size to micrometer-size particles of anode active material, for example graphite particles 106, intimately mixed with like-size particles of a selected solid electrolyte 108 and other components such as polymer binder and conductive particles. (Not shown in figure) In this example, the composition of the solid electrolyte particles 108, intimately mixed with the graphite anode material particles 106, is Li_{9.6}P₃Si₁₂. For purposes of comparison with other examples of the selection of suitable solid electrolyte particles for an electrode member, the composition of the solid electrolyte material for an anode of a lithium-ion cell is also designated in this text as SE1.

In the embodiment of FIG. 1, the opposite side of the layer of anode material 104 is in face-to-face, coextensive contact with an interlayer 110 which is the thinner (like a flat film) than the layer of anode material 104 and the solid electrolyte layer 112 of solid electrolyte particles 114 (typically resin-bonded) which intimately engages the opposite side of interlayer 110. The composition of interlayer 110 is suitably a mixture of polyethylene oxide (PEO) and lithium bis(trifluoromethanesulfonyl)imide (LiTFSI). The composition of the small particles 114 of solid electrolyte layer 112, is suitably Li₁₀GeP₂S₁₂ (LGPS). Again, for comparison with other embodiments of the selection of the composition of suitable solid electrolyte materials, the composition of the particles of the solid electrolyte layer is herein designated or referred to as SE2.

Placed in intimate, coextensive contact with the opposite side of solid electrolyte layer 112, is a layer 116 of cathode material. Cathode material layer 116 is suitably formed of a mixture of nanometer-size to micrometer-size particles of cathode active material 118, particles of suitable solid electrolyte material 120 and other components such as polymer binder and conductive particles. (Not shown in figure). An example of the composition of a suitable cathode active material is LiNbO₃-coated LiNi_{0.5}Mn_{1.5}O₄, and a suitable compatible solid electrolyte material is Li₇La₃Zr₂O₁₂/polyvinylidene fluoride (PVDF)/lithium bis(trifluoromethanesulfonyl)imide (LiTFSI) hybrid electrolyte (SE3). Attached in face-to-face-coextensive contact with the opposite side of cathode layer 116 is cathode current collector 122 with its optional tab 122′ for connection with an energy requiring device. During cell discharge, cathode current collector displays a positive electrical charge.

Thus, in the embodiment of FIG. 1, each of the solid electrolyte materials is of a different composition. SE1≠SE2≠SE3. SE1 and SE3 are selected to electrochemically match well with anode material and cathode material, respectively. It is desirable that SEs are not continuously decomposed during cycling and that a stabilized micro interface is built up to ensure a lower interfacial resistance and extend the cycling life. Suitably the interlayer, is selected to avoid the side-reaction between high-ionic-conductivity SE2 with electrode active materials, while enabling an intimate macro interfacial connection and minimizing the interfacial resistance.

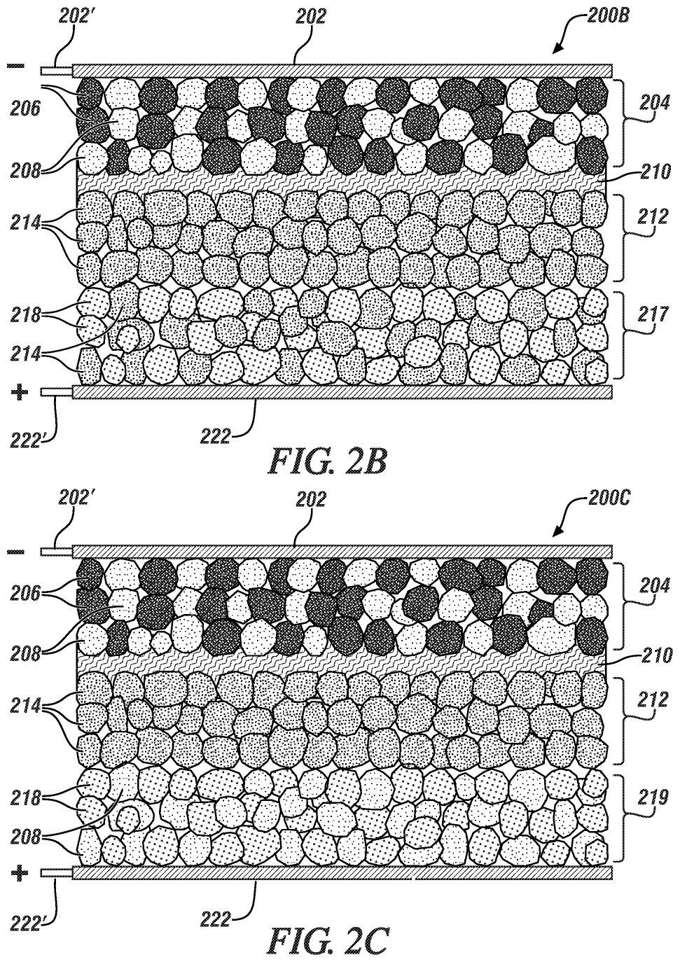

In the embodiments of FIGS. 2A-2C, various combinations of compositions of solid electrolyte materials are demonstrated.

In FIGS. 2A-2C, lithium ion cells 200A-200C are constructed, similarly composed and illustrated like that in FIG. 1. In the illustrations of FIG. 2A-2C, the related elements of the lithium ion cell assemblies, which are unchanged with respect to FIG. 1, are numbered 2xx in which the values of xx are the same as in FIG. 1. And, in these embodiments, the compositions of the particles of anode active material 206 and the particles of cathode active material 218 are of the same compositions as the corresponding anode particles 106 and cathode particles 118 used in the anode layer 104 and cathode layer 116 used in the lithium-ion battery cell 100 of FIG. 1. And the composition of the interlayer 210 is the same in each of FIGS. 2A, 2B, and 2C. But the compositions of the solid electrolyte particles which are changed are given new numbers.

In the embodiment illustrated in FIG. 2A, the composition of the particles of solid electrolyte material 214 used in the anode layer 205 and the particles of solid electrolyte 214 used in the solid electrolyte layer 212 are the same. SE1=SE2. But the composition of the solid electrolyte particles 218 used in cathode layer 216 are unchanged from the solid electrolyte particles 118 used in the cathode layer 116 of FIG. 1. In the lithium-ion battery cell 200A of FIG. 2A, SE1=SE2≠SE3.

In the lithium-ion battery cell 200B illustrated FIG. 2B, the compositions of the particles of solid electrolyte material 214 used in the cathode layer 217 and the particles of the solid electrolyte 214 used in the solid electrolyte layer 212 are the same. SE2=SE3. But the composition of the solid electrolyte particles 208 used in the anode layer 204 is unchanged from the FIG. 1 embodiment. SE1≠SE2=SE3.

And in the lithium-ion battery cell 200C illustrated in FIG. 2C, the compositions of the solid electrolyte material 208 used in the anode layer 204 and in, an again modified, cathode layer 219 are the same, but they differ from the composition of solid electrolyte particles 214 in the solid electrolyte layer 212. SE1=SE3≠SE2. Again, it is desirable that SEs are not continuously decomposed during cycling, and that a stabilized micro-interface is built up to ensure a lower interfacial resistance and extend the cycling life. Suitably the interlayer, is selected to avoid the side-reaction between high-ionic-conductivity SE2 with electrode active materials, while enabling an intimate macro-interfacial connection and minimizing the interfacial resistance.

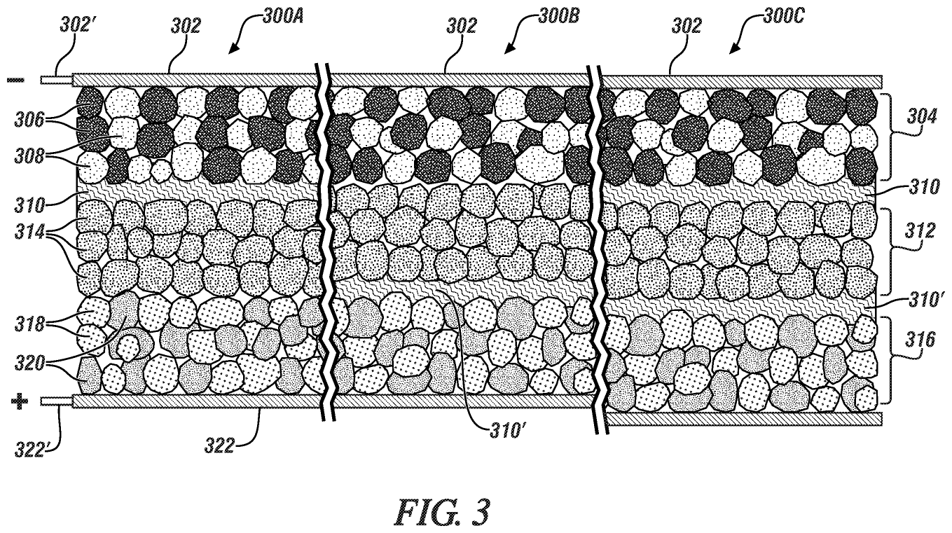

In the embodiments of the solid-state lithium-ion battery cell illustrated in the fragmented schematic cross-sectional view of FIG. 3, the use of one or more interlayers between a layer of electrode material and the solid electrolyte layer is illustrated.

In the broken-off view at the left side of FIG. 3, the cross-sectional view of the lithium-ion battery cell 300A is the same is the illustration of FIG. 1. The members of the cell structure are numbered 3xx in which the values of xx correspond to the 1xx values presented in FIG. 1. In the illustration of lithium-ion battery cell 300A, interlayer 310 is positioned between anode layer 304 and solid electrolyte layer 312. Illustrative compositions of the respective members and constituents of the broken-off cells 300A, 300B and 300C are the same as provided for the members and constituents of the cell 100 in FIG. 1. As stated with respect to interlayer 110 of FIG. 1 positioned between anode layer 104 and solid electrolyte layer 112, the composition of interlayer 110 and 310 may, for example be PEO-LiTFSI.

In the broken-off view of solid-state lithium-ion battery cell 300B at the center of FIG. 3, a single interlayer 310′ is placed between solid electrolyte layer 312 and cathode layer 316. An example of a suitable composition of interlayer 310′, positioned between the specified solid electrolyte layer 312 and the cathode layer 316, is 70% Li₂S-29% P₂S₅-1% P₂O₅. And in the broken-off view of solid-state lithium-ion battery cell 300C at the right side of FIG. 3, an interlayer 310 is positioned between anode layer 304 and solid electrolyte layer 312, and interlayer 310′ is placed between the specified solid electrolyte layer 312 and the cathode layer 316. Preferably, the interlayer material is selected and placed between anode layer and SE layer to provide good reduction stability and a softened nature to enable a good contact with other particles.

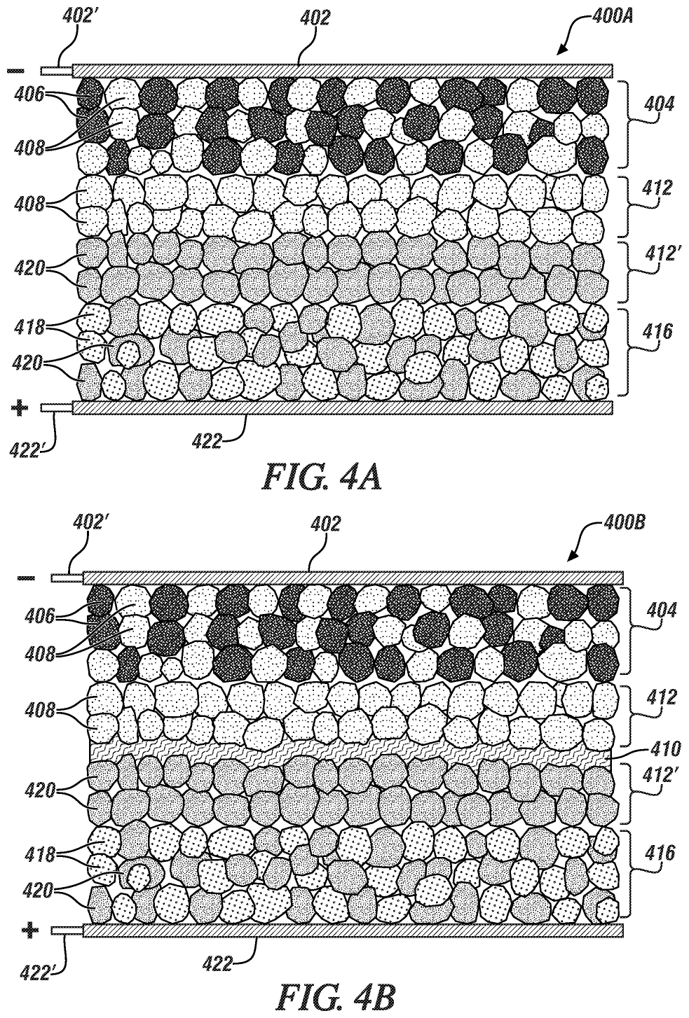

In the embodiments of the disclosure presented and illustrated in FIGS. 4A and 4B, changes are made in the organization of the solid electrolyte. In FIG. 4A, the solid electrolyte layer is assembled with a first particulate solid electrolyte composition layer 412 adjacent to and co-extensive with the anode electrode layer 404 and with a second layer of solid electrolyte particles 412′ adjacent to and coextensive with the cathode layer 416. In FIG. 4A the anode electrode layer 404 may, for example, be composed of a mixture of graphite particles 406 as anode active material and solid electrolyte particles 408 of Li_{9.6}P₃S₁₂ (SE1). The first layer of solid electrolyte material 412 is also composed of particles of Li_{9.6}P₃S₁₂. Cathode layer 416 may, for example, be composed of a mixture of LiNbO₃-coated LiNi0.5Mn1.5O4 cathode particles 418, mixed with Li₇La₃Zr₂O₁₂/polyvinylidene fluoride (PVDF)/lithium bis(trifluoromethanesulfonyl)imide hybrid solid electrolyte particles 420. And the second layer of solid electrolyte material 412′ also is formed of Li₇La₃Zr₂O₁₂/polyvinylidene fluoride/lithium bis(trifluoromethanesulfonyl)imide hybrid solid electrolyte particles 420. Thus, the two-layer solid electrolyte 412, 412′ matches the solid electrolyte materials 408, 420 used on the anode layer 404 and the cathode layer 416.

In the embodiment of FIG. 4B, an interlayer 410 of PEO-LiTFSI is interposed between the described layers 412, 412′ of solid electrolyte materials 408, 420. Sometimes, the SE layer of 412 or 412′ is very thin, which will cause short-circuit of battery. Then, a thin film interlayer is introduced to reduce the short-circuit risks and build a good contact between 412 and 412′.

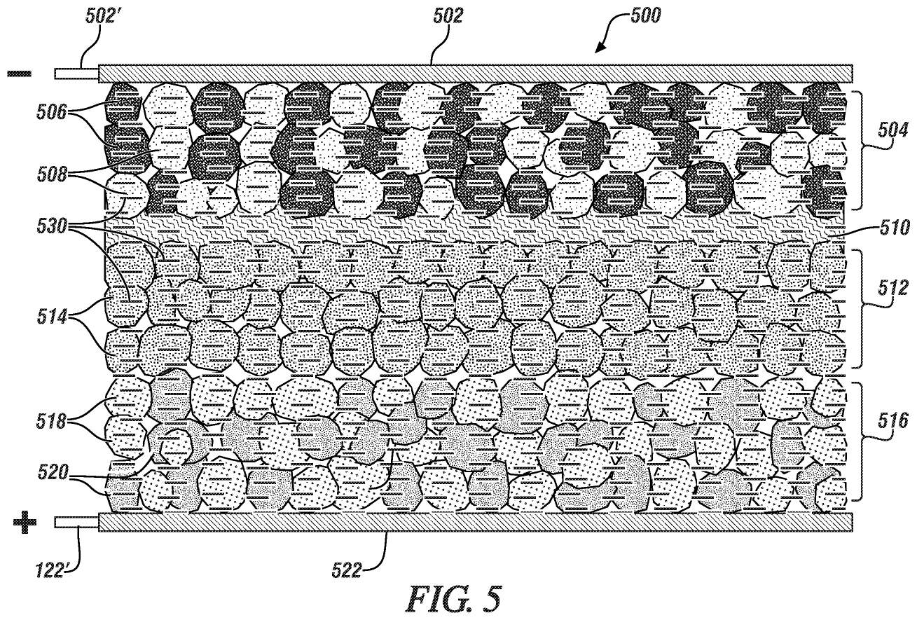

In the embodiment of FIG. 5 an otherwise solid-state lithium-ion battery cell is infiltrated with a suitable quantity of a liquid electrolyte. For purposes of illustration, the solid-state lithium ion battery cell of FIG. 1 is used. The numerals 5xx identifying the materials and constituents of the cell correspond to the values of 1xx applied and described in that figure. However, in the embodiment of FIG. 1, the entire cell 500 has been infiltrated with a non-aqueous liquid electrolyte, indicated by black line dashes (-). The compositions of the electrode and solid electrolyte materials presented in FIG. 5 may be considered the same as in FIG. 1. In that embodiment the composition of a suitable liquid electrolyte is Li(triethylene glycol dimethyl ether)bis(trifluoromethanesulfonyl)imide (Li(G3)TFSI) solvate ionic liquid.

While the use of a liquid electrolyte in combination is illustrated with the illustrated lithium-ion solid state cell of FIG. 1 and the electrode and electrolyte compositions described therein, the use of a suitable liquid electrolyte may be used in any of the lithium-ion solid state battery structures and selected solid electrolyte combinations described above in this specification. The ionic contact between the electrode/electrolyte particles is solid-solid, which is still not so sufficient as conventional liquid-based lithium-ion battery. Adding a liquid electrolyte into the battery can build favorable ionic contacts.

The above description of preferred exemplary embodiments and specific examples are descriptive in nature; they are not intended to limit the scope of the claims that follow. Each of the terms used in the appended claims should be given its ordinary and customary meaning unless specifically and unambiguously stated otherwise in the specification.

What is claimed is:

1. A solid-state lithium-ion battery cell comprising
an anode member which is in the form of a layer having a two-dimensional size and shape with opposing facial sides and a uniform thickness up to about 500 micrometers, the anode layer comprising a bonded mixture of particles of anode active material and solid electrolyte particles of a first solid electrolyte composition, the respective particles having maximum dimensions in the nanometer and micrometer range up to about 1000 micrometers;
a solid electrolyte member which is in the form of a layer comprising bonded solid electrolyte particles of a second electrolyte composition, the solid electrolyte layer having a two-dimensional size and shape with opposing facial sides and a uniform thickness up to about 500 micrometers, the solid electrolyte layer having a first facial side facing toward a facial side of the anode layer and an opposing facial side, the solid electrolyte particles having maximum dimensions in the nanometer and micrometer range up to about 1000 micrometers;
a cathode member which is in the form of a layer having a two-dimensional size and shape with opposing facial sides and a uniform thickness up to about 500 micrometers, the cathode layer comprising a bonded mixture of particles of cathode active material and solid electrolyte particles of a third solid electrolyte composition, the respective particles having maximum dimensions in the nanometer and micrometer range up to about 1000 micrometers, the cathode layer having a first facial side facing toward the opposing facial side of the layer of solid electrolyte particles; and
a co-extensive interlayer film placed in face-to-face contact between opposing facial sides of the anode layer and the solid electrolyte layer or between opposing facial sides of the cathode layer and the solid electrolyte layer, or in both locations;
the first solid electrolyte composition, the second solid electrolyte composition, and the third solid electrolyte composition being such that at least one of the solid electrolyte compositions is different from the other two solid electrolyte compositions.

2. A solid-state lithium-ion battery cell as stated in claim 1 in which each of the three solid electrolyte compositions is different from the other two solid electrolyte compositions.

3. A solid-state lithium-ion battery cell as stated in claim 1 in which the first solid electrolyte composition and the third solid electrolyte compositions are the same, but they differ from the second solid electrolyte composition.

4. A solid-state lithium-ion battery cell as stated in claim 1 in which the second and third solid electrolyte compositions are the same, but they differ from the first solid electrolyte composition.

5. A solid-state lithium-ion battery as stated in claim 1 in which the first solid electrolyte and the second solid electrolyte compositions are the same, but they differ from the third solid electrolyte composition.

6. A solid-state lithium-ion battery as stated in claim 1 in which an interlayer film comprising a mixture of polyethylene oxide and lithium bis(trifluoromethanesulfonyl)imide is placed between the anode member layer and the solid electrolyte member layer, or between the solid electrolyte member layer and the cathode member layer, or in both locations.

7. A solid-state lithium-ion battery as stated in claim 1 in which the solid electrolyte layer comprises a first layer of solid electrolyte particles facing the anode layer and having the same composition as the particles of the solid electrolyte composition of the anode layer, and a second layer of solid electrolyte particles facing the cathode layer and having the same composition as the solid electrolyte composition of the cathode layer.

8. A solid-state lithium-ion battery as stated in claim 7 in which an interlayer is placed between the two solid electrolyte layers.

9. A solid-state lithium-ion battery as stated in claim 1 in which the anode layer, the layer of solid electrolyte, and the cathode layer are porous and are uniformly infiltrated with a liquid electrolyte conductive of lithium cations and compatible with the solid electrolyte.

10. A solid-state lithium-ion battery as stated in claim 1 in which (i) the anode layer comprises a bonded mixture of graphite particles as anode active material and particles of Li_{9.6}P₃S₁₂ as solid electrolyte particles, (ii) the solid electrolyte layer comprises bonded particles of Li₁₀GeP₂S₁₂, and (iii) the cathode layer comprises a bonded mixture of LiNbO₃-coated LiNi_{0.5}Mn_{1.5}O₄ particles of cathode active material and particles of Li₇La₃Zr₂O₁₂/polyvinylidene fluoride/lithium bis(trifluoromethanesulfonyl)imide hybrid electrolyte as solid electrolyte particles.

11. A solid-state lithium-ion battery as stated in claim 1 in which an interlayer film comprising a mixture of polyethylene oxide and lithium bis(trifluoromethanesulfonyl)imide is placed between the anode member layer and the solid electrolyte member layer, or between the solid electrolyte member layer and the cathode member layer, or in both locations.

12. A solid-state lithium-ion battery as stated in claim 1 in which (i) the anode member layer comprises a mixture of graphite particles as anode active material and particles of Li₁₀GeP₂S₁₂ as solid electrolyte particles, (ii) the solid electrolyte member layer comprises particles of Li₁₀GeP₂S₁₂, and (iii) the cathode member layer comprises a mixture of LiNbO₃-coated LiNi_{0.5}Mn_{1.5}O₄ particles of cathode active material and particles of Li₇La₃Zr₂O₁₂/polyvinylidene fluoride/lithium bis(trifluoromethanesulfonyl)imide hybrid electrolyte as solid electrolyte particles.

13. A solid-state lithium-ion battery as stated in claim 1 in which (i) the anode member layer comprises a mixture of graphite particles as anode active material and particles of Li_{9.6}P₃S₁₂ as solid electrolyte particles, (ii) the solid electrolyte member layer comprises particles of Li₁₀GeP₂S₁₂, and (iii) the cathode member layer comprises a mixture of LiNbO₃-coated LiNi_{0.5}Mn_{1.5}O₄ particles of cathode active material and particles of Li₁₀GeP₂S₁₂ as solid electrolyte particles.

14. A solid-state lithium-ion battery as stated in claim 1 in which (i) the anode member layer comprises a mixture of graphite particles as anode active material and particles of Li_{9.6}P₃S₁₂ as solid electrolyte particles, (ii) the solid electrolyte member layer comprises particles of Li₁₀GeP₂S₁₂, and (iii) the cathode member layer comprises a mixture of LiNbO₃-coated LiNi_{0.5}Mn_{1.5}O₄ particles of cathode active material and particles of Li_{9.6}P₃S₁₂ as solid electrolyte particles.

15. A solid-state lithium-ion battery as stated in claim 1 in which (i) the anode member layer comprises a mixture of graphite particles as anode active material and particles of Li_{9.6}P₃S₁₂ as solid electrolyte particles, (ii) the solid electrolyte member layer comprises a first layer of particles of Li_{9.6}P₃S₁₂ lying adjacent to the anode member layer and a second coextensive layer of particles of Li₇La₃Zr₂O₁₂/polyvinylidene fluoride/lithium bis(trifluoromethanesulfonyl)imide hybrid solid electrolyte lying adjacent to the cathode member layer, and (iii) the cathode member layer comprises a mixture of LiNbO₃-coated LiNi_{0.5}Mn_{1.5}O₄ particles of cathode active material and particles of Li₇La₃Zr₂O₁₂/polyvinylidene fluoride lithium bis(trifluoromethanesulfonyl)imide hybrid electrolyte as solid electrolyte particles.

16. A solid-state lithium-ion battery as stated in claim 15 in which a solid interlayer film is placed between the first solid electrolyte layer and the second solid electrolyte layer.

17. A solid-state lithium-ion battery as stated in claim 15 in which the interlayer comprises a mixture of polyethylene oxide and lithium bis(trifluoromethanesulfonyl)imide.

18. A solid-state lithium-ion battery as stated in claim 9 in which the liquid electrolyte is lithium bis (trifluoromethane sulfonyl) imide-triethylene glycol dimethyl ether ionic liquid.

19. A solid-state lithium-ion battery cell comprising
an anode layer having a two-dimensional size and shape with opposing faces and a uniform thickness, the anode layer comprising a mixture of particles of anode active material with particles of a first solid electrolyte composition;
a layer of solid electrolyte particles of a second electrolyte composition, the electrolyte layer having a two-dimensional size and shape and a uniform thickness, the solid electrolyte layer having a first face lying against a face of the anode layer and an opposing face; and
a cathode layer having a two-dimensional size and shape with opposing faces and a uniform thickness, the cathode layer comprising a mixture of particles of cathode active material with particles of a third solid electrolyte composition, the cathode layer having a first face lying against the opposing face of the layer of solid electrolyte particles;
a co-extensive interlayer film placed in face-to-face contact between opposing facial sides of the anode layer and the solid electrolyte layer or between opposing facial sides of the cathode layer and the solid electrolyte layer, or in both locations;
the first solid electrolyte composition, the second solid electrolyte composition, and the third solid electrolyte composition being such that at least one of the solid electrolyte compositions is different from the other two solid electrolyte compositions.

20. A solid-state lithium-ion battery as stated in claim 19 in which the interlayer film comprises a mixture of polyethylene oxide and lithium bis(trifluoromethanesulfonyl)imide.
